(19) United States
(12) Patent Application Publication
(10) Pub. No.: US 2012/0144885 A1
(43) Pub. Date: Jun. 14, 2012

(54) Fiber Optic Cable Lock System

(76) Inventor: Ian Michael Mills, Aurora, CA (US)

(21) Appl. No.: 12/965,893

(22) Filed: Dec. 12, 2010

(51) Int. Cl. E05B 47/00; H01J 40/14

(52) U.S. Cl. 70/57.1; 250/216

(57) ABSTRACT

A cable alarm system is provided that includes: a lock; a temper proof fiber optic cable coupled to the lock and operative to conduct a light signal; an LED and a light signal detector coupled to the fiber optic cable and operative to detect light from the LED; a battery; a GPS system and a wireless transceiver. On detection of light signal interruption, the cable alarm system sends a wireless message containing GPS information.

### FIELD OF THE INVENTION

The present invention relates to an alarmed cable locking system.

### BACKGROUND OF THE INVENTION

The present invention relates to monitoring trailers and containers while in transit. In particular, this invention relates to a portable and reusable electronic device that is easily installed on a container and that enables to detect intrusions and to locate and track the container using a cell phone or a computer.

To lock a container, one closes both of the doors that are typically on the rear of a shipping container, and places locks on each door handle. Variations on this approach include bars, cables and housings. The lock key is generally kept with the driver.

GPS systems can be positioned on containers and can report the container location through a wireless network. These systems can also be combined with sensors and can report actions such as a door was opened.

A GPS navigation receiver coupled with a cell phone, and attached to a shipping container is disclosed in U.S. Pat. No. 5,835,377, issued Nov. 10, 1998, to Ronald Bush. These systems are not portable.

LoJack™ system in the United States, permanently attaches a wireless transceiver to a mobile object such as a truck or car. The transceiver range and the type of data it provides are highly dependent upon the application and upon the vehicle remaining in range of terrestrial radio networks. This system is not portable.

U.S. Pat. No. 6,975,224 by Galley et al. presents a reusable self-contained electronic device providing in-transit cargo visibility. It discloses a system containing a GPS and cellular modem that is easily installed and removed by the user and that allows a user to monitor a container through the Internet.

A typical cable locking system consists of a strong cable and a physical lock, which secures the ends of the cable together, forming a strong loop which can be used to secure an object to another object to prevent theft. The conventional locking systems, however, can be defeated with the proper tools, such as with a torch, which can burn through the cable, or with very strong bolt cutters.

Some cable lock systems provide an alarm that sounds when the cable is cut or when the lock unit is moved or broken.

There is a need for a more convenient, effective, and tamper proof method and apparatus for monitoring container locations and providing remote status information.

### SUMMARY OF INVENTION

A tamper proof cable lock system comprising a fiber optic cable, wherein said fiber optic cable is configured to be coupled to said tamper proof cable lock system and to form a loop, wherein said tamper proof cable lock system can be remotely armed and disarmed, wherein a light signal can be transmitted through said fiber optic cable, wherein on detection of disconnect of said light signal while said tamper proof cable lock system is armed, said cable lock system sends current location information wirelessly to a remote destination.

A portable tracking and intrusion detection system comprises a mechanical lock coupled to a second electronic fiber optic cable lock, wherein a light transmitter transmits a light signal through a first end of a fiber optic cable, wherein a light sensor detects a light signal on the other end of said fiber optic cable,

wherein on detection of a disconnect of said light signal, said portable tracking and intrusion detection system sends current location information wirelessly to a remote destination.

A fibre optic cable lock, comprising: a lock; an electric cable having a first end and a removable second end configured to be coupled to said lock to form a closed loop and adapted to conduct a light signal; a light detector coupled to said lock and configured to detect a light signal in said fibre optic cable when said second end is couple to said lock; an alarm; a GPS system for detecting current location information; a transceiver for sending alarm message to remote destination;

wherein on detection of disconnect of said light signal; said fiber optic cable lock sends current location information wirelessly to a remote destination.

### BRIEF DESCRIPTION OF THE DRAWINGS

The present invention with be more clearly understood after reference to the following detailed specifications read in conjunction with the drawings wherein:

FIG. 1 is a diagram illustrating a container equipped with a container tracking device

FIG. 2 is a schematic of a cable lock with fiber optic cable

FIG. 3 is a block diagram illustrating a cable lock with fiber optic cable

FIG. 4 is a flowchart illustrating the operation of a cable lock with fiber optic cable

Similar reference numerals are used in different figures to denote similar components.

### DETAILED DESCRIPTION OF THE PREFERRED EMBODIMENTS

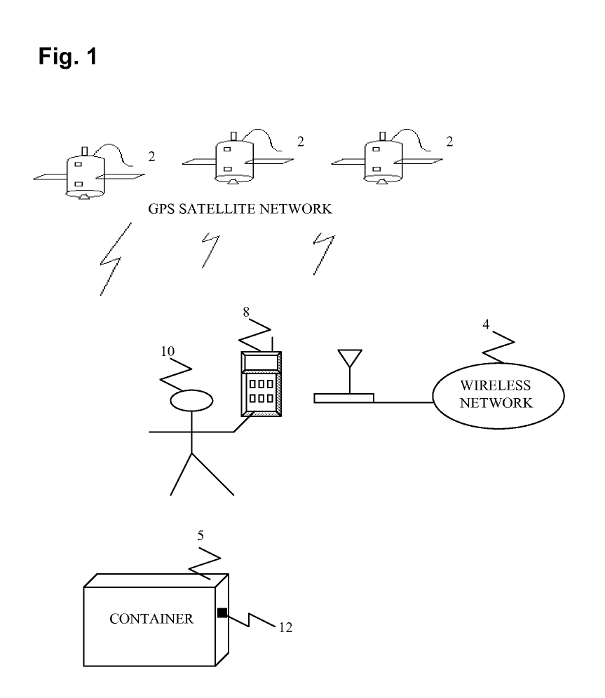

Referring to FIG. 1, a container 5 equipped with a removable container tracking device 12 collaborates with GPS constellation 2 to determine position information. Container tracking device 12 collaborates with wireless network 4 to receive commands and to send position information to user 10 through wireless network 4 and mobile terminal 8.

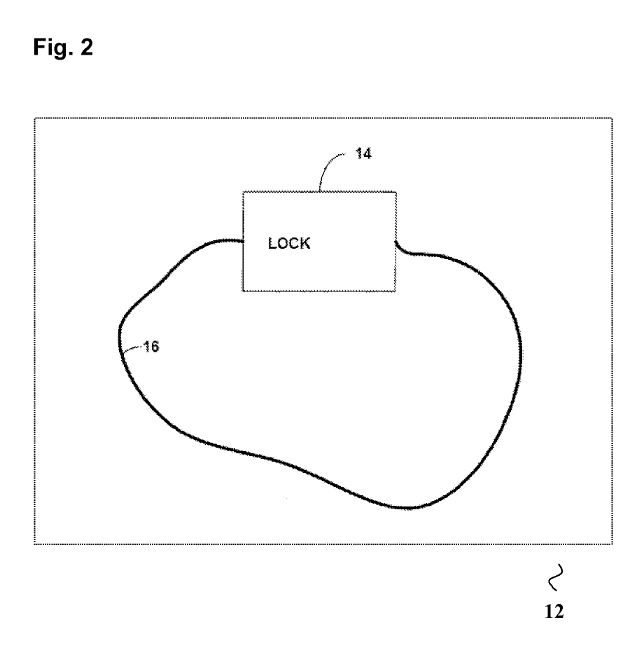

Referring to FIG. 2, container tracking device 12 comprises cable 16 and lock 14. Cable 16 can be a fiber optic cable. Alternatively, cable 16 can be a wire, a retractable wire, a retractable fiber optic cable or any other cable. Lock 14 is used to connect or disconnect cable 16 and to form a loop or open the loop. It includes a system that detects if cable 16 forms a loop, or if the loop is open or broken. It also comprises a GPS receiver, a transceiver and a siren.

When lock 14 detects that cable 16 is disconnected or cut, it starts a siren, and sends a message wirelessly to a remote location comprising its current GPS location.

Lock 14 may also include any standard lock means available on the market that allows locking and unlocking container doors using a key. The standard lock may be welded to cable lock 12 or may share an enclosure with it. In this scenario, a container transporter may keep the key for the standard lock, and a controller may keep the PIN code to the cable lock.

In order to open the container door, first, the driver must unlock the container door using the key, and second, the controller must send a wireless unlock message to the cable lock.

In order to lock the container door, first, the driver must lock the container door using the key, and second, the controller must send a wireless lock message to the cable lock. If the container doors are opened without consent from the controller, an alarm is activated and a wireless message is sent to the controller containing the location of the incident.

Lock 14 includes an attachment system to attach the fiber optic cable. Example: blot system, clip system, magnetic system, screw system, etc.

Cable 16 loops around protected areas and locks to lock 14. The signal detector detects an interruption of a signal in said cable and triggers an alert, a siren and/or an SMS/call message to a remote terminal. The alert also contains GPS location information obtained from an onboard GPS receiver. The signal detector can be a light detector that detects optic signals, or a simple switch that detects current. A signal transmitter is used to send a light signal (or an electrical signal) to the cable.

When locked, an intruder is not able to open container doors without disconnecting cable 16 from its lock or cutting it.

Electrical cables are not reliable for use with cable locks because they are easy to short. A thief may go around an cable lock with electrical cables by connecting a second electrical cable to lock 14 connectors, and cutting the original cable. In this case, the alarm will not go off. Fiber optic cables are a very important part of the cable lock as they cannot be shorted or easily tampered with.

Container tracking device 12 can be armed by pressing a button or receiving SMS or other message such as Bluetooth or GPRS.

If the system is in ARMED mode and cable 16 is disconnected or severed, an alarm is triggered, and a wireless message containing current location information is sent wirelessly.

When in an ARMED state, container tracking device 12 can be disarmed by keying a PIN code through an onboard keypad, or by receiving wireless message. A PIN code is any secret code.

Lock 14 may include a drum for rotation during unwinding and winding-on of a fiber optic cable 16, a strap, a line, or a wire, the free end of which preferably is provided with an end piece adapted to be inserted to an opening in the lock casing and to be secured with the aid of a lock. When the end piece is locked within the casing, container tracking device 12 may be armed.

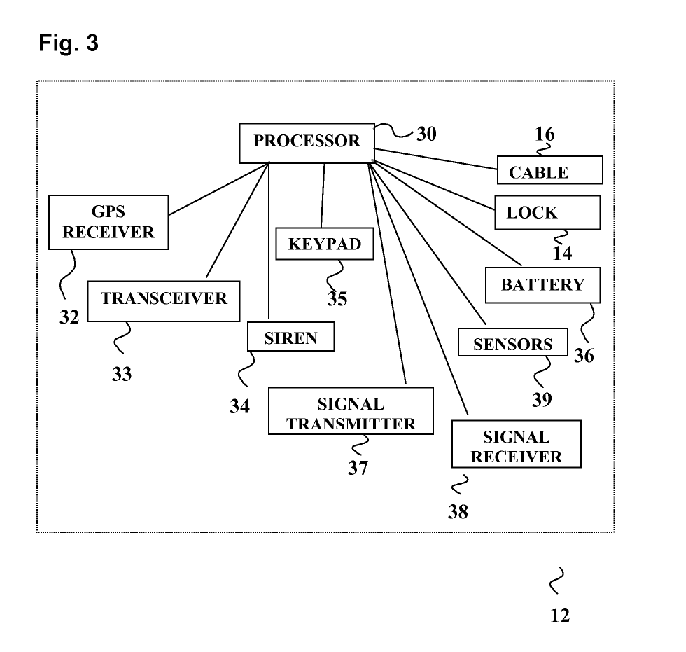

Referring to FIG. 3, container tracking device 12 comprises processor 30, lock 14, cable 16, GPS receiver 32, transceiver 33, siren 34, keypad 35, battery 36, signal transmitter 37, signal receiver 38 and sensors 39.

Container tracking device 12 is powered using battery 36. Lock 14 is used to connect and disconnect cable 16. Cable 16 is a flexible fiber optic cable. Cable 16 may be protected by a system or protective gear that prevents bending. Signal transmitter 37 is a light transmitter or LED. Signal receiver 38 is a light detector. In another embodiment, cable 16 is an electric cable and signal receiver 38 detects current.

GPS receiver 32 may be a GSP, GLONASS, LORAN, GNSS, or any other commercially available service, or combination of services, which provide global position information. Transceiver 33 may be any cellular receiver capable of SMS or GPRS through wireless network 4.

SMS is Short Message Service. It is available on wireless networks allowing text messages of up to 160 characters to be sent and received via the network operator's message center to a mobile phone/portable terminal, or from the Internet, using a so-called “SMS gateway” website. If the mobile phone/portable terminal is powered off or out of range, messages are stored in the network and are delivered at the next opportunity.

GPRS is General Packet Radio Service, a data transmission technique that transmits and receives data in packets between portable terminals/mobile phones or between a portable terminal/mobile phone and a second terminal.

Siren 34 is any alarm or siren with more than 85 decibels.

Battery 36 is any battery that can power the cable lock system. It will be understood that battery 44 may be nickel-cadmium, lithium, alkaline or nickel-hydride battery or any other portable source of electric power.

Key pad 35 may be used to arm/disarm container tracking device 12. Processor 30 obtains location information from GPS receiver 32 and may correlate it to location names from memory.

Processor 30 may receive trigger events through cellular transceiver 33 and send location information.

In an alternative embodiment, on receipt on an SMS message, processor 30 replies with a new SMS message containing location and/or status information.

In an alternative embodiment, on receipt on an SMS message containing data, processor 30 authenticates the message data then replies with a new SMS message containing location and/or status information.

In an alternative embodiment, on receipt on an SMS message containing instructions, processor 30 executes said instructions. Said instructions may indicate reporting position to a specific phone number such as police station or to a number of phone numbers.

Processor 30 may periodically send position and/or status information to a destination number.

Processor 30 may transfer data through data packets, data stream, voice information, file transfer or any other data transfer method.

Processor 30 monitors sensors 39 to detect exception events such as intrusion, deviation from a path, abnormal driving, accident, abnormal conditions such as high temperature, or any condition that is a cause for concern. Processor 30 may compare sensor 39 data against user thresholds established in a flash drive. On deviation from user thresholds, an alarm mode is entered.

On detection of a signal disconnect while container tracking device 12 is armed, siren 34 triggers an alarm. Transceiver 33 sends an SMS/call message/digital message to a remote terminal. The message comprises GPS location information obtained from GPS receiver 32.

Alternatively, container tracking device 12 can be armed by pressing a button on keypad 35 or receiving SMS/digital message or other message through transceiver 33.

When ARMED, container tracking device 12 can be disarmed by entering a PIN code using keypad 35, or by receiving a remote wireless signal through transceiver 33. Sensor 39 may comprise a shock detector, an accelerometer or a 3D motion detector. It can be used to detect if somebody is tampering with the cable lock and to trigger an alarm.

Sensor 39 may comprise a heat sensor to detect fire and to trigger an alarm. Sensors 39 may be any sensors for detecting intrusion, door opening, motion, temperature, sound, beam crossing, light, acceleration, or any other conditions. Sensors 39 may be electronic seal, actuators, motors, contact switches/sensors, reed switches, buttons, infrared/ultrasound sensors, heat sensors, light sensors, acceleration sensors, or any other sensors capable of detecting intrusion.

When container tracking device 12 is not in operation it remains in a dormant state (“sleep-mode”) to conserve the energy of battery 36.

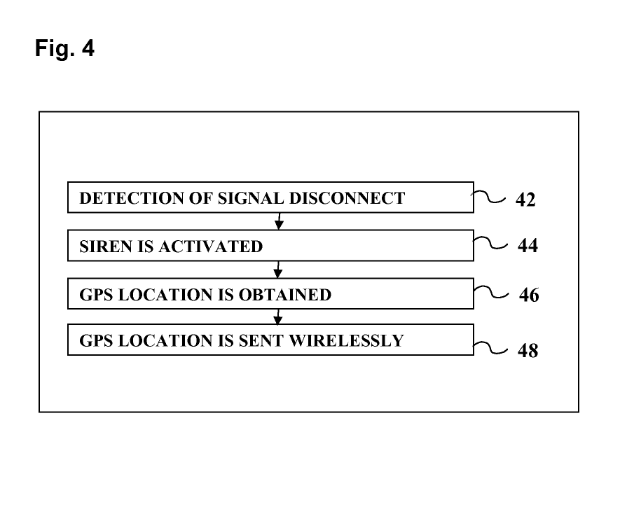

Referring now to FIG. 4, in step 42, on detection of signal disconnect, siren 34 is activated in step 44, GPS location is obtained in step 46 and is sent wirelessly in step 48. The wireless message may include an alarm and status note. A signal disconnect occurs as a result of cable 16 being disconnected or cut. In that case, the light sensor will not detect the light signal sent from the light transmitter, and will trigger an alarm.

Numerous other modifications, variations, and adaptations may be made to the particular embodiment of the invention described above without departing from the scope of the invention, which is defined in the claims. Hence, while exemplary embodiments of the present invention have been set forth above, it is to be understood that the pioneer inventions disclosed herein may be constructed or used otherwise than as specifically described.

What is claimed is:

1. A tamper proof cable lock apparatus comprising a fiber optic cable,
wherein said fiber optic cable is configured to be coupled to said tamper proof cable lock system and to form a loop,
wherein said tamper proof cable lock system can be remotely armed and disarmed,
wherein a light signal can be transmitted through said fiber optic cable,
wherein on detection of disconnect of said light signal while said tamper proof cable lock system is armed,
said cable lock system sends current location information wirelessly to a remote destination.

2. The portable tracking and intrusion detection apparatus of claim 1 wherein on receipt of a wireless message containing a code, said cable lock system is armed or disarmed.

3. The portable tracking and intrusion detection apparatus of claim 1 wherein said wireless message is selected from the set comprising SMS, Bluetooth, GPRS message.

4. The portable tracking and intrusion detection apparatus of claim 1 wherein on receipt of a pin code from an onboard keypad, said cable lock system is armed or disarmed.

5. The portable tracking and intrusion detection apparatus of claim 1 wherein said light signal is generated using an onboard LED.

6. A portable tracking and intrusion detection apparatus comprises a mechanical lock coupled to a second electronic fiber optic cable lock,
wherein a light transmitter transmits a light signal through a first end of a fiber optic cable,
wherein a light sensor detects a light signal on the other end of said fiber optic cable,
wherein on detection of a disconnect of said light signal,
said portable tracking and intrusion detection apparatus sends current location information wirelessly to a remote destination.

7. Portable tracking and intrusion detection apparatus of claim 6 wherein said light transmitter is an LED.

8. A fibre optic cable lock, comprising:
a lock;
an electric cable having a first end and a removable second end configured to be coupled to said lock to form a closed loop and adapted to conduct a light signal;
a light detector coupled to said lock and configured to detect a light signal in said fibre optic cable when said second end is couple to said lock;
an alarm;
a GPS system for detecting current location information;
a transceiver for sending alarm message to remote destination;
wherein on detection of disconnect of said light signal;
said fiber optic cable lock sends current location information wirelessly to a remote destination.

9. The fibre optic cable lock of claim 8, comprising:
a protective gear, said protective gear prevents said fibre optic cable from bending.

10. The fibre optic cable lock of claim 8, wherein said fibre optic cable is retractable.

11. The fibre optic cable lock of claim 8, wherein said fibre optic cable lock is removable.
